(19) United States
(12) Patent Application Publication
(10) Pub. No.: US 2022/0219838 A1
(43) Pub. Date: Jul. 14, 2022

(54) MODEL RESETTING IN A TURBINE ENGINE

(71) Applicant: SAFRAN AIRCRAFT ENGINES, Paris (FR)

(72) Inventors: Rudy Charles André AULNETTE, MOISSY-CRAMAYEL (FR); Cedrik DJELASSI, MOISSY-CRAMAYEL (FR); Emmanuel Mickaël EBURDERIE, MOISSY-CRAMAYEL (FR); Mehdy EL KONNADI, MOISSY-CRAMAYEL (FR)

(73) Assignee: SAFRAN AIRCRAFT ENGINES, Paris (FR)

(21) Appl. No.: 17/604,069

(22) PCT Filed: May 13, 2020
(86) PCT No.: PCT/FR2020/050793

§ 371 Date: Oct. 15, 2021

(30) Foreign Application Priority Data
May 13, 2019 (FR) 1904976
May 13, 2019 (FR) 1904979

(51) Int. Cl. B64F 5/60; B64D 33/00; B64D 45/00; G05B 13/04

(52) U.S. Cl. CPC B64F 5/60; G05B 13/04; B64D 45/00; B64D 33/00

(57) ABSTRACT

The present intention relates to a method for resetting the static pressure model (mod_Ps3(PCN25R)), called “Ps3 model”, upstream of a combustion chamber in a turbine engine comprising a compressor (3), the Ps3 model being used to arbitrate between two acquisition channels (V10, V20) of the static pressure (Ps3), called “Ps3 pressure”, upstream of the combustion chamber, the two acquisition channels (V10, V20) using two sensors (10, 20), the model expressing the pressure Ps3 as a function at least of the speed (PCN25R), called “PCN25R speed”, of the compressor (3), and comprising the following steps: E1: measuring a value of the pressure Ps3 using one of the two sensors (10, 20); E2: resetting the Ps3 model using the measurement of the value of Ps3.

### FIELD OF THE INVENTION

The present invention relates to updating predictive models in the context of a turbine engine.

As a preliminary point, several definitions are given. As illustrated in FIG. 1, it is considered within the framework of a turbine engine 1 comprising two successive compressors 2, 3 (low pressure 2 and high pressure 3 compressor) followed by a combustion chamber 4. These definitions are applicable for the entire application.

Ps3 is the static pressure measured or calculated in the plane upstream of the combustion chamber.

Xn12R is the speed of the low pressure compressor 2, reduced on the temperature of said compressor T12 (to avoid temperature variations), expressed in revolutions per minute.

PCN12R (or N1 in the case of a direct drive) is the speed of the low pressure compressor 2, reduced on T12 (to avoid temperature variations), expressed in percentage of maximum low pressure speed.

Xn25R is the speed of the high pressure compressor 3, reduced on T25 (to avoid temperature variations), expressed in revolutions per minute.

PCN25R (or N2) is the speed of the high pressure compressor 3, reduced on the temperature of said compressor T25 (to avoid temperature variations), expressed in percentage of maximum high pressure speed.

PT2 is the total external pressure (supplied by the aircraft).

P25 is the modeled static pressure in the high pressure compressor.

A model is a mathematical law describing the evolution of a physical quantity (parameter) as a function of one or more physical variables.

### STATE OF THE ART

During operation, turbine engines sometimes undergo false pumping detections (stalling of the blades of one of the two compressors) during cruising phase. These events have a strong operational impact (engine endoscopy) and are dangerous.

In these two cases, a deviation failure between the two channels Ps3, that is to say between the two channels for acquiring the static pressure upstream of the combustion chamber was observed when the events took place.

The impact of false pumping detections has a significant operational impact in the sense that the aircraft is immobilized until the engine has been endoscoped to check for damage.

The acquisition line Ps3 sometimes consists of a pipe which takes the pressure upstream of the combustion chamber 4 and two pressure sensors located directly in the aircraft calculator (FADEC, for full authority digital engine control).

The measurement of Ps3 is carried out using two independent sensors. In order to consolidate the information from the two sensors, a selection logic between the two sensors has been implemented. It is assumed here that the sensors are taking valid measurements (no power failure and the measurement is within a physically plausible range of measurements), and that the two sensors are taking measurements that are deviated from each other. This configuration causes a deviation failure, but it is impossible to vote for either measurement, not knowing which is closest to the actual value Ps3.

To overcome this problem, a Ps3 model based on thermodynamic laws is calculated. This model theoretically allows to remove the doubt by providing a third quantity (analytical redundancy), independent of the measurements of Ps3, which will allow to vote for one or the other of the readings via the selection logic. FIG. 2 illustrates this principle, with the two acquisition channels V10, V20, the model mod_Ps3 and the switch which occurs when the channel V10 again becomes closer to the model mod_Ps3 than the channel V20 which had diverged from the channel V10 previously. The switch causes the calculator to observe a significant pressure variation ΔPs3.

However, in practice, model values that are quite remote from the real value of Ps3 are observed. This can lead to erroneous channel arbitration. The applicant noticed, after studies, that the false detection of pumping was due to a sudden change in selection of Ps3: as the two measurements of Ps3 were deviated, the selected channel went from the strongest measurement in Ps3 to the lowest measurement in one calculation pitch since the model was initially closer to the most significant Ps3 and then closer to the weakest Ps3. It is this false jump ΔPs3 of at least 15% relative value that can trigger a false pumping detection when the pressure has not actually dropped.

There is therefore a need to guard against this type of event, in particular by improving the management of arbitration, in particular concerning the pressure Ps3, but for any other parameter.

More generally, there is a need to better process thermodynamic models, so that they better reflect reality, whether for Ps3 or other parameters.

In addition, various improvements or uses of the thermodynamic model could be made to improve the speed, efficiency and relevance of thermodynamic models.

The patent application references US 2014/326213 A1, EP 2 434 127 A2, US 2019/080523 A1 and US 2017/218854 A1 are also known.

### DESCRIPTION OF THE INVENTION

A purpose of the invention is to provide solutions to the mentioned problems.

To this end, a method is proposed for resetting the static pressure model upstream of the combustion chamber, called “Ps3 model”, in a turbine engine comprising a compressor, the Ps3 model being used to arbitrate between two acquisition channels of the static pressure upstream of the combustion chamber, called “pressure Ps3”, the two acquisition channels involving two sensors,

the method using a Ps3 model stored in a memory, the model expressing the pressure Ps3 as a function at least of the speed of the compressor, called “speed PCN25R” and comprising the following steps:

E1: measuring a pressure value Ps3, by one of the two sensors.

E2: resetting the Ps3 model using the measurement of the Ps3 value.

In one embodiment, the Ps3 model is a Ps3 model on the compressor pressure, called “pressure P25”, the model being called “model PS3/P25”.

In one embodiment, the model Ps3/P25 is expressed as a function of the compressor speed, reduced on its temperature, called “temperature T25”, called “speed PCN25R” or “speed Xn25R”.

In one embodiment, the resetting is performed on the Ps3/P25 model as a function of the speed PCN25R.

In one embodiment, the compressor is a high-pressure compressor, when the turbine engine further comprises a low-pressure compressor upstream of the high-pressure compressor.

In one embodiment, the model Ps3 is defined by segments according to and the resetting step consists in resetting each segment.

In one embodiment, in each segment the model PS3 is linear.

In one embodiment, the step of resetting by segment is carried out using a corrector, for example an integral corrector.

In one embodiment, the model PS3 is further expressed as a function of the low-pressure compressor speed, reduced on its temperature, called “temperature T12”, called “speed PCN12R”.

In one embodiment, the model PS3 is further expressed as a function of the total external pressure, called “pressure T2”.

In one embodiment, the model PS3 is defined by plane and the resetting step consists in resetting each plane.

In one embodiment, the PS3 model to be reset is selected based on the level of aircraft air bleed in the compressors and the memory stores a plurality of models PS3 expressed as a function of the aircraft air bleed.

A method for arbitrating between two acquisition channels is also proposed, said method comprising the following steps:
A1: implementing a resetting method as described above,
A2: selecting the acquisition path closest to the reset model.

A method for analyzing the aging of a turbine engine is also proposed, the method consisting in implementing the following steps:
F1: Implementing a resetting method as described above,
F2: Saving the reset model in a non-volatile memory,

steps F1 and F2 being repeated at least twice, and preferably more,
F3: Comparing the different reset models to deduce an evolution of the state of the turbine engine therefrom.

To this end, a method is proposed for resetting a model of the operating parameter of a turbine engine or of an aircraft,

the model being defined as a law by segment indicating the value of said parameter as a function of a variable, or being defined as a law by plane indicating the value of said parameter as a function of two operating variables,

said law being affine on each segment or being affine on each plane, the parameter model being stored in a memory.

The operating parameters and variables are for example related to a temperature or a pressure, or else to a compressor speed (typically the speeds Xn12 and Xn25 of the low pressure body and of the high pressure body. More generally, they can be any operating parameter for which there is a measurement and a model allowing analytical redundancy.

The resetting method comprises the following steps:
obtaining a value of the parameter,
calculating an error by comparing said value of the parameter with the corresponding value of the model, said value of the model belonging to one of the segments or planes of the model,
applying a corrector by minimizing said error to determine a correction,
resetting the segment of the model or the plane of the model using the correction, to reposition said segment or plane and thus obtain a reset model of the physical parameter.

In one embodiment, the step of obtaining the value of the parameter is performed by:
a direct measurement of said parameter using a sensor, or
a measurement of a third-party parameter on which said parameter depends, or
a simulation.

In one embodiment, the corrector is a PID corrector or an integral corrector.

In one embodiment, when the model is a law by segment, the resetting is done by freezing a point of the segment and by moving another point of the segment using the correction, the two points preferably being the ends of the segment.

In one embodiment, when the model is a law by segment, the resetting is done by not keeping any point of the segment fixed, for example by moving the two ends of the segment using the correction.

In one embodiment, the movement of the ends of the segment is done depending on their respective distance from said corresponding value of the model.

In one embodiment, the distribution of the correction to be applied to one end of the segment is equal to the ratio of the distance of the corresponding value of the model to the other end of the segment, over the length of the segment.

In one embodiment, the step of resetting the segment of the model comprises a linear interpolation between two reset points.

In one embodiment, when the model is a law by plane, the plane has the shape of a rectangle which is cut into triangles, and the resetting is done by freezing one or two vertices of the triangle and moving the last two vertices or the last vertex of the triangle using the correction.

In one embodiment, when the model is a law by plane, the plane is cut into triangles, and the resetting is done by moving the three vertices of the triangle.

In one embodiment, the movement of each vertex of the triangle is done depending on the area of the sub-triangle defined by the other two vertices and said corresponding value of the model.

In one embodiment, the distribution of the correction to be applied to a vertex of the triangle is equal to the ratio of the area of the sub-triangle defined by the other vertices and said corresponding value of the model, to the area of the triangle.

In one embodiment, the step of resetting the triangle comprises a linear interpolation from the reset points.

In one embodiment, the parameter is the pressure Ps3 or the pressure Ps3 divided by the pressure P25 and wherein:
the variable is, when the model is a law by segment, the speed PCN25R and
the variables are, when the model is a law by plane, the PCN25R and the PCN12R, or the PCN25R and the PT2.

In one embodiment, the model to be reset is selected according to a variable, the memory stores a plurality of models expressed as a function of the aircraft air bleed, the variable possibly being the level of aircraft air bleed in the compressors.

In one embodiment, the corrector gains are different for different segments or planes of the model.

A method for analyzing the aging of a turbine engine is also proposed, the method consisting in implementing the following steps:
F1: Implementing a resetting method as described above,
F2: Saving the reset model in a non-volatile memory,

steps F1 and F2 being repeated at least twice, and preferably more,
F3: Comparing the different reset models to deduce an evolution of the state of the turbine engine therefrom.

### DESCRIPTION OF THE FIGURES

Other features, purposes and advantages of the invention will emerge from the following description, which is purely illustrative and not limiting, and which should be read with reference to the appended drawings wherein:

FIG. 1 schematically illustrates a turbine engine.

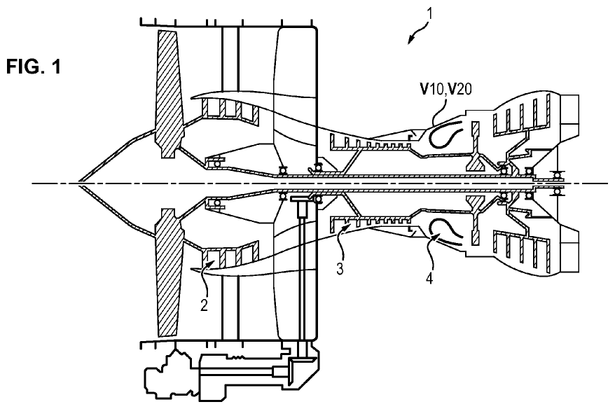

FIG. 2 illustrates a method for arbitrating between two acquisition channels using a thermodynamic model.

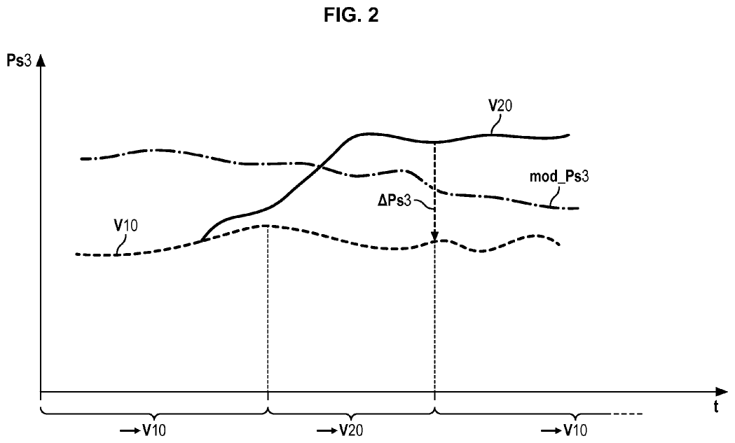

FIG. 3 graphically illustrates a method for resetting the pressure Ps3.

FIG. 4 illustrates a block diagram of a method for resetting a parameter model, such as the pressure Ps3.

FIG. 5 illustrates a corrector.

FIGS. 6a and 6b illustrate methods for resetting a 2D model by segment.

FIG. 7a illustrates, for a segment, a method for resetting a 2D model into a segment by weighting.

FIG. 7b illustrates, for several segments, a method for resetting a 2D model into a segment by weighting.

FIG. 8 illustrates a 3D model by plane.

FIG. 9 illustrates a block diagram of a method for resetting a 3D model of a parameter, such as the pressure Ps3, as a function of the pressures PCN12R and PCN25R.

FIG. 10a illustrates, for a plan, a method for resetting a 3D model in segment by weighting.

FIG. 10b illustrates the choice of a triangle among the rectangle forming a plane of the 3D model.

FIG. 10c illustrates the choice of the weighting for a triangle among the rectangle forming a plane of the 3D model.

FIG. 11 illustrates by a block diagram a model selection as a function of a variable, prior to the resetting of the model.

FIG. 12 illustrates a method for analyzing the turbine engine aging.

### DETAILED DESCRIPTION OF THE INVENTION

The context and definitions given in the introduction are repeated here.

First of all, a method for resetting the static pressure model upstream of the combustion chamber will be described. This pressure will be called pressure Ps3 and this model will be called “Ps3 model” and referenced mod_Ps3. This is a thermodynamic model.

The final purpose of the Ps3 model is in particular to allow to arbitrate between two redundant acquisition channels V10, V20, the function of which is to measure the pressure Ps3. Each acquisition channel V10, V20 comprises a sensor 10, 20. The sensor 10, 20 is standard and will not be described here.

A method for arbitrating between the two acquisition channels V10, V20 will be described below.

A calculation unit 100 is provided, which comprises a processor 110 and a memory 120. The calculation unit 100 can be a FADEC (“full authority digital engine control”) or else be a separate component, positioned as close as possible to the acquisition channels V10, V20 for more responsiveness.

The memory 120 stores a model mod_Ps3, which allows to obtain the value of the pressure PS3 as a function at least of one variable Var, which is the speed PCN25R (high pressure compressor speed): the model mod_Ps3 is then written under the form mod_Ps3(PCN25R). In practice, the model mod_Ps3 involves several sub-models, such as in particular the Ps3 model on the pressure of the high-pressure compressor P25 (this model is called mod_Ps3/P25) and the model mod_Ps3/P25 is in turn expressed as a function of the speed of the high-pressure compressor PCN25R reduced on its temperature T25. This model is then written in the form mod_Ps3/P25(PCN25R/T25).

Then it is sufficient to multiply the value of Ps3/P25 by P25 to get the value of Ps3.

Rather than directly resetting the model mod_Ps3, it is thus preferable to reset the model mod_Ps3/P25. The denomination of “Ps3 model”, in the form mod_Ps3, includes models which do not directly express pressure Ps3 but allow it to be obtained subsequently, such as the model mod_Ps3/P25.

In a first step E1, one of the two acquisition channels V10, V20, using its sensor 10, 20, measures a value Val_Ps3 of the pressure Ps3 on the turbine engine (for a real value of the physical quantity which is used as a variable, that is to say PCN25R). At this stage, it is assumed that the two acquisition channels V10, V20 are sound and that the two sensors 10, 20 give a correct measurement. In other words, there is no failure of sensors 10, 20 or deviation beyond a predetermined threshold between the two measurements.

This measurement of a value Val_Ps3 of the pressure Ps3 is then sent to the calculation unit 100.

A step E2 of conversion or of processing data can be implemented: for example, Val_Ps3 is a value of static pressure Ps3, while the model mod_Ps3/P25 uses the pressure Ps3 reduced on the P25: it is therefore necessary to divide the value of the static pressure by P25 to obtain the value Val_Ps3/P25.

Then, in a step E3, the calculation unit 100 resets the Ps3 model stored in its memory 120 using said measurement of the value of the pressure Ps3. Resetting means that there exists at least one point of the model mod_Ps3 (in practice a plurality, or even an infinity, if the model is continuous) whose ordinate has been shifted (therefore with constant abscissa). The reset model is noted Rmod_PS3/P25. Subsequently, the writing will be simplified by keeping mod_PS3/P25 which designates a model before and after resetting.

In this case, there is at least one point P of the curve mod_Ps3(Var) whose value Val_mod_Ps3(Var) has changed before and after the resetting, for a value of the given variable. In the preferred embodiment, mod_Ps3/P25(PCN25R) and Val_mod_Ps3/P25(PCN25R) are used.

Finally, a step E4 of storing the reset Ps3 model in memory 120 is defined. In one embodiment, the reset model mod_Ps3 (in this case mod_Ps3/P25) replaces by deleting the previous model in the memory 120. In another embodiment, it does not delete it.

Preferably, the steps E1, E2 and E3 are repeated at regular intervals, of the type at each calculation pitch. The calculation pitch corresponds to approximately 0.015 s. During a calculation pitch, the two steps E1 and E3 can be implemented or else a step E1 and in parallel the step E3 using the data from step E1 of the previous pitch are implemented.

As the model mod_Ps3 is updated at regular intervals, the arbitration can be done more quickly and therefore more correctly, avoiding the jumps ΔPs3 related to the untimely channel V10, V20 change.

The resetting is advantageously carried out using a corrector 112 which is integrated in a loop of the control chain. This corrector will be described in detail below.

A method for arbitrating between two acquisition channels V10, V20 is also defined, the arbitration method comprising a step A1 of implementing a resetting method as described above and a step A2 of selecting the acquisition channel V10, V20, during which the processor selects a channel V10, V20 among the two channels V10, V20. The choice is made according to the acquisition channel V10, V20 which is closest to the reset model. The step A2 is conventional and will not be described here.

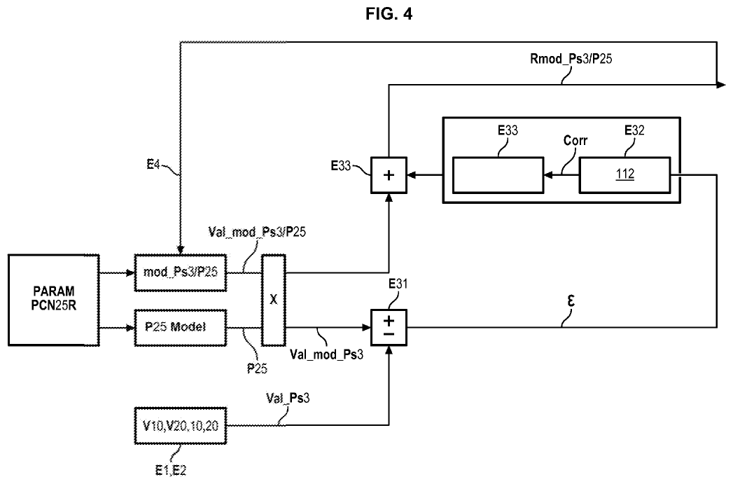

Secondly, a specific method for resetting a model mod_PARAM of turbine engine or aircraft parameter (for example temperature, pressure, in absolute or in relative terms) will be described, with reference to the general representation of FIG. 4. “Parameter of interest” will be discussed. The model is again a thermodynamic model. The model describes the change in the parameter as a function of one or more variables Var which are also in reality turbine engine or aircraft parameters (for example temperature, pressure, in absolute or relative terms). It is stored in the memory 120 of the calculation unit 100.

This method is fully applicable to the method for resetting the pressure Ps3 described above. The pressure Ps3 will also be used as an example of parameter PARAM and the pressure PCN25R as variable Var but the method can be applied to any physical parameter PARAM of an aircraft and any variable Var (for example pressure PT2): for example mod_Ps3/P25(PCN25R), mod_Ps3/P25(PCN25R, PCN12R), mod_Ps3/P25(PCN25R, PT2), mod_T25(PCN12R, PT2), mod_Xn25(PCN12R, PT2) where Mach is the speed of the aircraft, mod_T3 (T25), etc.

A model is defined here as a law by segments (in a configuration called 2D configuration) or by plane (in a configuration called 3D configuration) indicating the value of said parameter of interest as a function respectively of a variable Var (2D) or of two variables Var1, Var2 (3D). The law is linear respectively on each segment (or in other words, piecewise affine: that is to say that its equation is in the generic form z=ax+c) or on each plane (equation in the generic form z=ax+by+c).

The interest of a model defined as a law by segment (2D) or by plane (3D) is the application of the principles of linear automation. For example, the model mod_Ps3/P25(Xn25r) or mod_Ps3/P25(PCN25R) is nonlinear in its entirety.

The same framework as before is considered, with the two acquisition channels V10, V20.

In a step E1, a value Val_PARAM of the parameter of interest PARAM is obtained. This can be obtained in the context of step E1 described above, by measuring a sensor 10, 20 of one or more acquisition channels V10, V20, in particular with the acquisition of a third-party parameter and said parameter of interest is deduced therefrom.

Alternatively or in addition, the parameter of interest PARAM can be obtained using a simulation.

The following steps and sub-steps are implemented by the processor 110 and the memory 120 of the calculation unit 100.

A data conversion step E2 can be implemented when the measured parameter does not correspond to the model parameter: for example, as explained previously, Val_Ps3 is a static pressure value Ps3, while the model mod_Ps3/P25 uses pressure Ps3 reduced on P25. In the case of a third-party parameter, said calculation unit 100 calculates a value of the parameter of interest Val_PARAM from the value of the third-party parameter.

Then, the resetting step E3 is implemented. This resetting step E3 comprises several sub-steps.

In a sub-step E31, the processor 110 recovers the value Val_mod_PARAM from the model mod_PARAM which corresponds to the value of the parameter of interest Val_PARAM obtained in step E1.

The value of the model Val_mod_PARAM is thus on one of the segments or planes of the model mod_PARAM. This correspondence can be done via the value of the variable Var of the model mod_PARAM: the value of the model Val_mod_PARAM whose abscissa corresponds to that of the value Val_PARAM of the parameter of interest is taken. For this purpose, it may be necessary to actually perform two measurements: one on the parameter PARAM and one on the variable Var, to have a pair of data.

In the case of the pressure Ps3, it is thus possible to have a measurement of the PCN25R at the same time as the measurement of the Ps3.

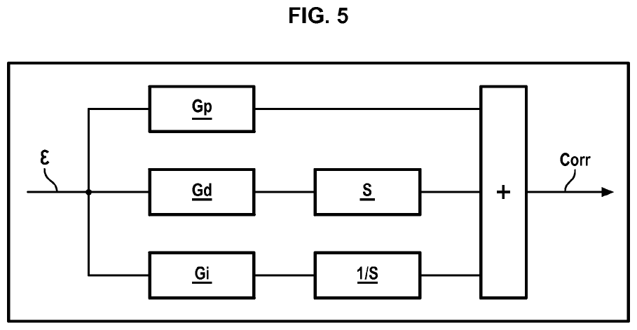

With the two values Val_mod_PARAM and Val_PARAM, the sub-step E31 comprises the calculation of an error ε, typically by subtraction: ε=Val_mod_PARAM-Val_PARAM. This error ε is illustrated in FIG. 5.

In a sub-step E32, this error ε is processed by a corrector 122, the role of which is to minimize said error ε. The corrector 122 allows to calculate a correction corr which is a deviation to be applied to the coordinates of the points of the corrected law, obtained via the corrector PID, from the error (deviation between the measurement and the model) and which must be brought to the model mod_PARAM. Due to the segmentation (segment or plane) of the model m_PARAM, the corrector is implemented only on the segment or plane considered during the implementation of step E3.

A particular corrector will be described below.

Finally, in a sub-step E33, the correction corr is used to reset the segment or the plane of the model mod_PARAM. This step consists in recalculating a segment or a plane, from the preceding model mod_PARAM and the correction corr calculated in the sub-step E32. In particular, the resetting consists in moving a minimum number of points of the model mod_PARAM in a sub-step E331 and in interpolating the rest of the model between these points in a sub-step E332: two points for the model by segments and three points for the model by plane.

Several embodiments of the resetting will be described below.

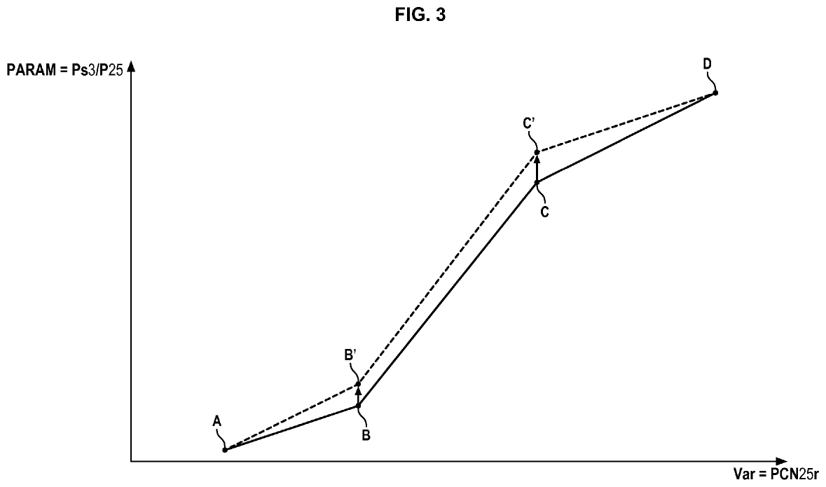

It is further noted, for example in FIG. 3, that the resetting of a segment will also influence the adjacent segments in the case where the end of the reset segment is moved. A step of interpolating the adjacent segments can further be implemented.

The corrector selected is a PID (proportional integral derivative) corrector, illustrated in FIG. 5, where Gp, Gd and Gi are respectively the gain of the proportional corrector, of the derivative corrector and of the integral corrector, S being the variable in the frequency domain (Laplace variable).

The integral corrector (the I of the PID) allows to introduce a certain inertia to the looped system, which allows to avoid hypersensitivity to disturbances and idle points, compared to an all or nothing corrector. The integral corrector also allows to control the resetting speed, and to avoid an instantaneous drift of the model m(param) towards the average between the two channels V10, V20 in the event of a drift of one of the sensors 10, 20.

A proportional corrector (the P of the PID) and a derivative corrector (the D of the PID) are implemented to more finely adjust the corrector 122 if necessary but are not used (the empirical approach has shown that their contribution is marginal compared to that of the integrator which naturally transcribes the desired behavior much better for the resetting). Gp=Gd=0 can thus be obtained.

The corrector is adjusted so that the model mod_PARAM is reset quickly enough to account for reconfigurations of the turbine engine (for example a change in the levels of air bleeds from the high pressure compressor).

Model by Segment (2D)

One places oneself here on the segment of the model mod_PARAM which is concerned by the measurement Val_PARAM carried out in step E1. This segment has two end points, on the left and on the right, noted A and B.

Point-by-Point Resetting

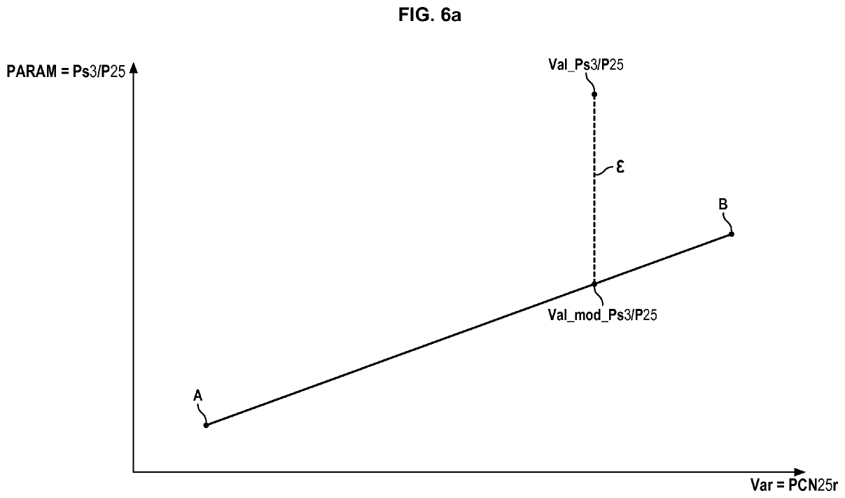

The first solution, illustrated in FIGS. 6a and 6b, consists in reporting the correction by modifying the coordinates of a single point of the segment, for example one of the end points A or B, while the other is frozen.

In this case, the output of the corrector 122 directly impacts point B (respectively point A), and point A (respectively point B) remains frozen. This solution however constrains to freeze at least one of the points of the model mod_PARAM to serve as a reference, from which the other segments of the model mod_PARAM will be impacted. Thus, during the resetting step E2 and more specifically during the sub-step E231, only one of the two end points is moved. Then, the interpolation step E232 is implemented.

This solution is the simplest and fastest to calculate.

Weighted Resetting of the Two Points of the Segment

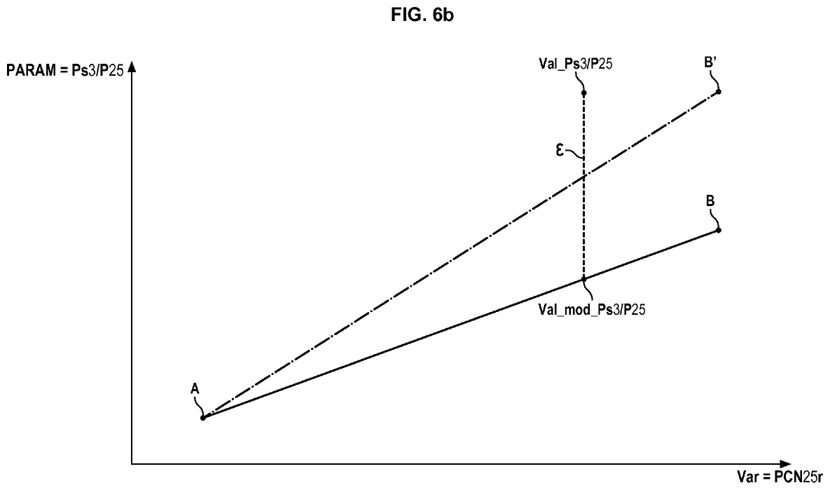

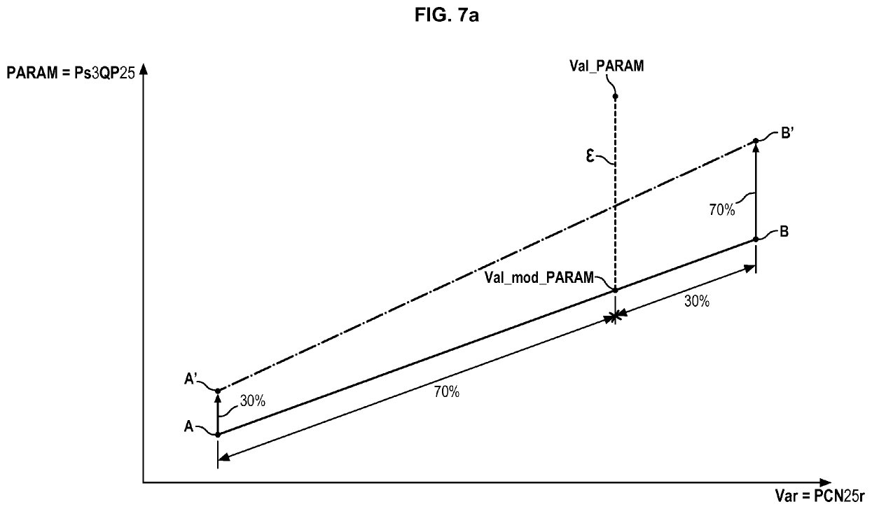

The second solution, illustrated in FIGS. 7a and 7b, consists in distributing the correction in a weighted manner to allow the selected segment to be reset in a more representative and more efficient manner. In an advantageous embodiment, the weighting is performed according to the distance between the value Val_PARAM, here Val_Ps3/P25, and the points A and B of the segment.

FIGS. 7a and 7b illustrate the resetting over an interval and a calculation pitch:
step E1: the measured value Val_PARAM is obtained by one or two acquisition channels V10, V20; in the example, this is Val_Ps3,
step E2 (image (a) of FIG. 7b): the measured value Val_PARAM is converted to be homogeneous with the model mod_PARAM; by simplification, the same reference Val_PARAM is kept,
step E31 (image (b) of FIG. 7b): ε which is the deviation between the measured value Val_PARAM and the value of the model Val_mod_PARAM is measured; in the example with the pressure Ps3: Val_PARAM=Val_PS3/P25, that is to say the measured pressure Ps3 divided by the pressure P25 model and Val_mod_PARAM=Val_mod_Ps3/P25, the pressure Ps3 of the reset model (by previous iterations) which is divided by P25 model,
step E32 (image (b) of FIG. 7b): the error ε is minimized via the corrector 122, by integrating it, to calculate a correction corr,
step E331 (FIG. 7a): the distance from the point Val_mod_PARAM, here Val_mod (Ps3/P25), to the point A, which constitutes the lower limit of the interval of the variable Var (here PCN25R), and which is a function of the linearization of the selected model, is then measured (or before step E31) relative to the distance between points A and B. Finally, the correction is distributed on the ordinate of points A (to give A′) and B (to give B′),
step E332 (image (c) of FIG. 7b): a new segment is interpolated between the two reset points A′ and B′.

The operating principle is to distribute the correction corr of the corrector 122 of an interval on the ordinates of the points A and B according to the same principle as previously: in one embodiment, X % of the correction is distributed on the ordinate of the point B, with X the ratio between the distance from point Val_mod_PARAM to point A on the distance from point A to point B. 100-X % of the correction is distributed on the ordinate of point A (30% and 70% on the FIG. 7a).

Once the two points A′ and B′ have been replaced, it suffices in step E232 to interpolate the model between these two points. Since the law is defined by segment, the linear (or affine) interpolation is simple.

Alternatively, any other (distinct) points of the segment can be moved by the correction: it suffices to select two points and the linear (or affine) interpolation allows to complete the rest of the considered segment.

This method thus allows an efficient and fast resetting to obtain a reset model mod_PARAM. However, since this model mod_PARAM depends only on one variable Var (PCN25R in the case of mod_Ps3), it may be insufficient for certain flight situations, in particular when the parameter of interest PARAM depends on several variables Var1, Var2.

Model by Plane (3D)

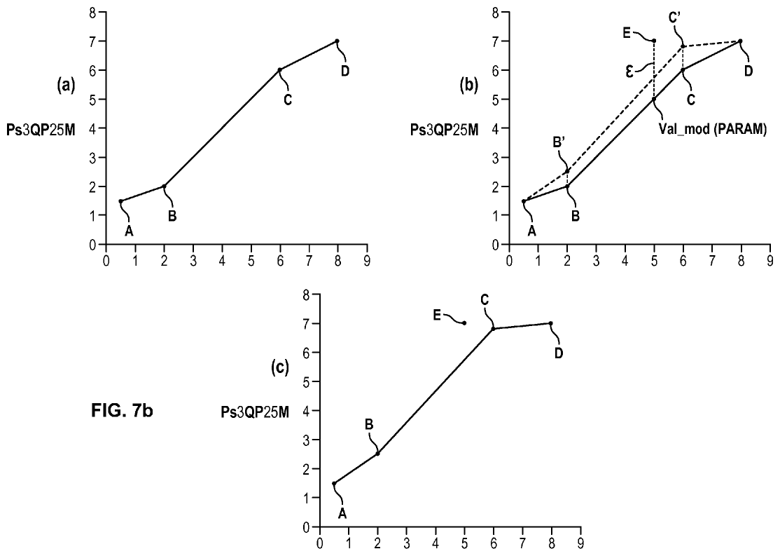

In this regard, to take into account several variables, the model mod_PARAM can be a function of two variables (mod_PARAM(Var1, Var2)) and be expressed in the form of a law defined by planes, the law being linear on each plane as shown in FIG. 8.

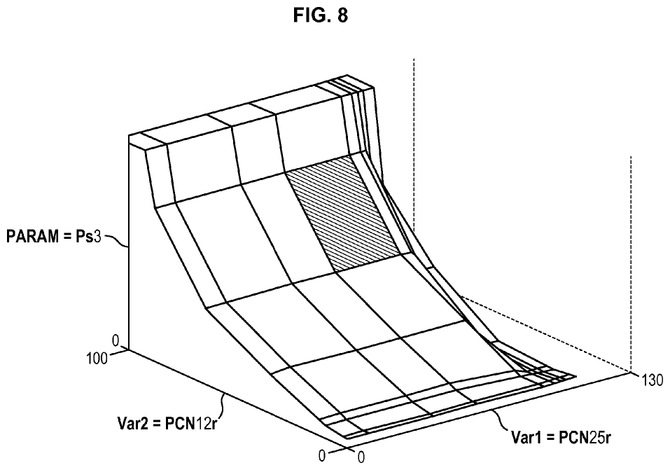

FIG. 9 illustrates the implementation of a resetting method in the case of a model by plane.

For example, in the case of the pressure Ps3, when activating an air bleed level, the model mod_Ps3/P25(PCN25R) (that is to say the model Ps3 reduced on P25 as a function of PCN25R) is modified because part of the air compressed by the high pressure compressor is sent to the aircraft air system). The corrector 122 of the 2D model by segment optionally allows to adapt to this reconfiguration if the gains of the corrector 122 are adjusted so that the resetting of the model is fast, but this can pose other difficulties.

The air bleed is performed from the primary flow. The air bled can be used by the aircraft (for example to pressurize the cabin . . . ). It can also be rejected in the secondary flow (VBV for Variable Bleed Valve, TBV for Turbine Bypass Valve), the purpose then being to reduce the pressure downstream of the compressor to avoid pumping. Depending on the volume of air required by the aircraft and the volume released into the secondary flow for engine regulation reasons, it is then possible to define air bleed levels. These bleed levels have an impact on the speed/Ps3 correlation since depending on the level of air bled, different pressures can be obtained for the same engine speed. Then it becomes difficult to define a model for regulating Ps3 according to the speed. The solution developed in the various embodiments to respond to this problem is to define several models, each model corresponding to a given level of air bleed. The corrector is then asked to change the model depending on the level of active air bleed at the given instant.

Still in the example of the pressure Ps3, to overcome the problem of air bleeds, a Ps3/P25 model which no longer depends only on PCN25R, but also on PCN12R, is then implemented: mod_Ps3/P25(PCN25R, PCN12R) is then defined. When activating direct bleeds, the law linking PCN25R and PCN12R is changed, which allows to take the reconfiguration of the system into account. The resetting of this law therefore requires a new “3D” corrector.

Point-to-Point Resetting

The first solution, not illustrated, consists in taking into account the correction by fixing the coordinates of a single point of the rectangle, for example one of the vertices A, B, C or D of the rectangle and by modifying the coordinates of two points of the rectangle, for example two of the vertices A, B, C or D. Alternatively, one can fix two points fixing the coordinates of two points of the rectangle, for example two of the vertices A, B, C or D of the rectangle and modifying the coordinates of a point of the rectangle, for example two of the vertices A, B, C or D.

The concerned points are moved during sub-step E331 then the interpolation step E332 over the entire rectangle is implemented. Since we are working on three points each time, the existence of the interpolated rectangle is ensured.

Weighted Resetting

To allow a weighted resetting, for which no point is fixed, the model mod_PARAM is linearized by cutting the rectangle ABCD into triangles ABC, ABD, typically two complementary triangles (FIG. 8). Indeed, three points A, B, C are always coplanar, before and after resetting, which ensures the existence of the interpolation of the triangle reset in the interpolation sub-step E332, once the sub-step E331 of resetting the three points is carried out. The three new points resulting from the correction can thus be used to describe the Cartesian equation of a plane, thus allowing to linearly interpolate the model mod_PARAM.

Indeed, if a correction weighted on three points of the surface were applied on four points, for example the four vertices ABCD of the rectangle, there would be a deformation of the rectangle if the four points of the rectangle were no longer coplanar (impossible to interpolate the coordinates of the parameter PARAM using the Cartesian equation of a plane).

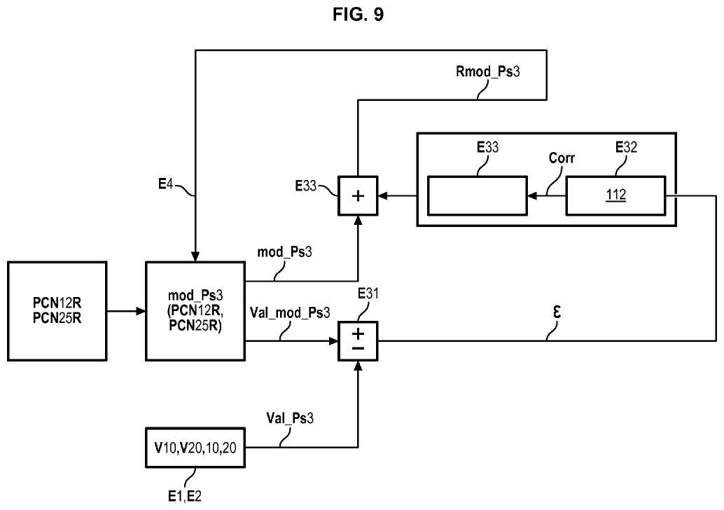

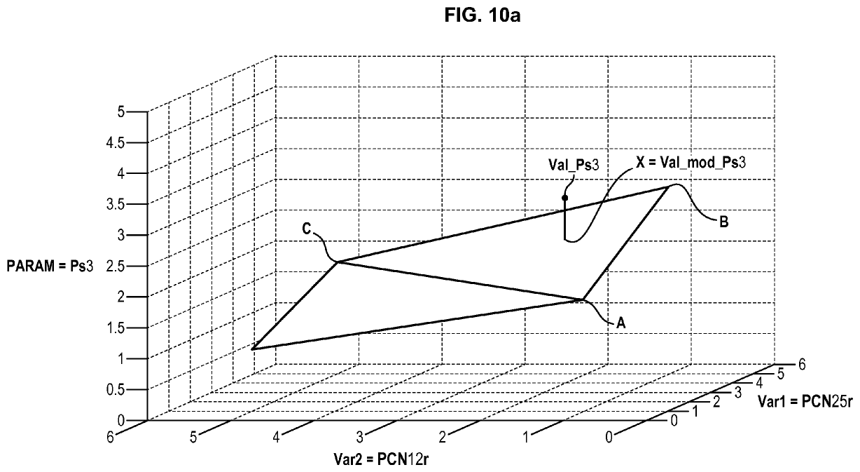

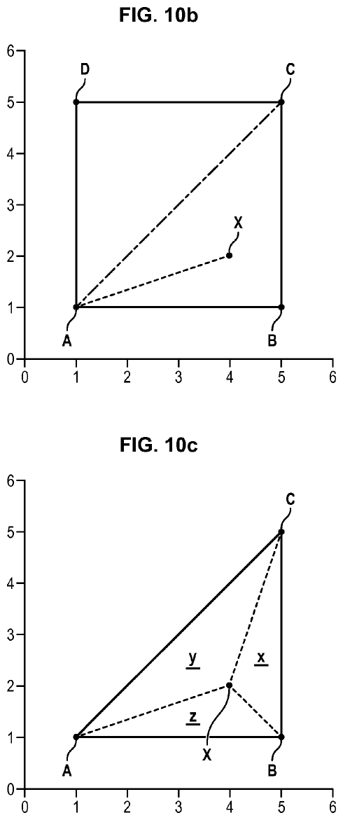

In sub-step E331, it is a matter of first selecting the triangle to be reset according to the value of Val_PARAM (called point X) obtained by steps E1 and E2. For this purpose, a difference in slope between the segment AC which divides the rectangle in two and the segment AX (FIG. 10b). Any vertex B, C or D can be used.

Indeed, with the four points A, B, C, D forming a rectangle and the point X corresponding to the measured point Val_PARAM, it is necessary to determine if X belongs to the triangle ABC or to the triangle ACD (it is recalled that these triangles were selected arbitrarily compared to ABD and DBC).

For this purpose, a comparison of the values of the variation rates ΔAC, ΔAX of the straight lines (AC) and (AX) is carried out during the sub-step E331. Indeed, if ΔAX>ΔAC then ACD is selected and if ΔAX≤ΔAC then ABC is selected. Then it is about distributing the correction.

Unlike the 2D model with segments, the distances between point X and the points of triangle ABC do not take into account the distribution of the correction to be applied. The distribution is therefore made in proportion to the areas of triangles XAB, XAC and XBC (FIG. 10c, where xis the area of XBC, y is the area of AXC and z is the area of XAB).

The ratios corr_A, corr_B, corr_C by corr_a=x/(x+y+z), corr_b=y/(x+y+z), and corr_z=z/(x+y+z) are defined.

The ratio corr_A is applied to the resetting of point A, corr_B to that of point B and corr_C to that of point D.

Finally, the interpolation sub-step E332 is implemented from the three points reset by a simple plane Cartesian equation, to interpolate the entire triangle.

Matrix (2D) Segment Model

It was said that the 2D segment model has limitations, in particular when another variable could have a strong influence on the model mod_PARAM.

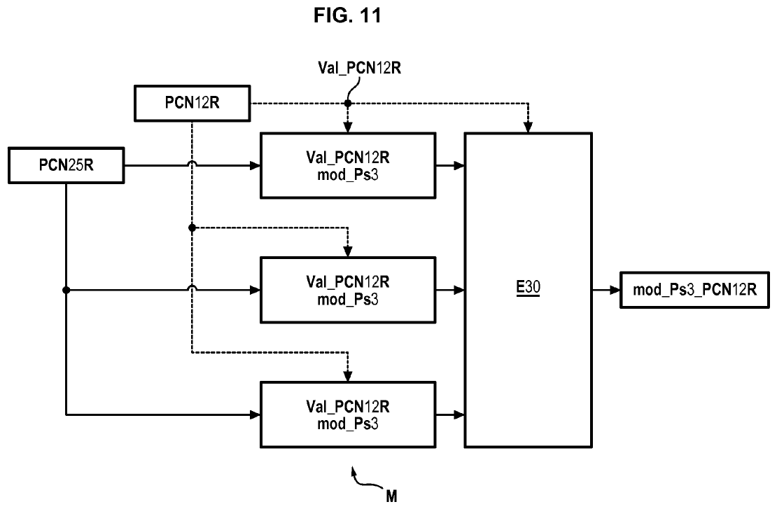

Illustrated in FIG. 11, another solution to take into account another variable consists in storing in the memory 120 a matrix M of 2D model mod_PARAM. Instead of having a model in the form mod_PARAM(Var1, Var2), there is a model in the form mod_PARAM_Var2(Var1), where mod_PARAM_Var2 designates an applicable model for a given value (or a set of given values) of the variable Var2.

FIG. 11 illustrates mod_Ps3_PCN12R(PCN25R). Here, PCN12R does not necessarily symbolize an exact value of the variable but a level, which can be an interval or be discrete.

In the case of the pressure Ps3 where the parameter PARAM is Ps3/P25 and where the variable Var1 is PCN25R, the memory 120 can store a plurality of models mod_Ps3 according to the bleeds, that is to say PCN12R.

In this embodiment, there is a limited number of stored models. Consequently, the values of PCN12R can be expressed by a number of levels of aircraft air bleed.

Consequently, before step E31 described above, the model mod_PARAM_Var2 is selected in a step E30, as a function of the value of the variable Var2, then the model mod_PARAM_Var2 is reset as a 2D model during steps E31, E32 and E33. Along with step E1, there is a step of measuring or acquiring the variable Var2 which determines the choice of the model mod_PARAM_Var2

Adjusting the Dynamics of the Correctors

The adjustment of the dynamics of the 2D corrector is carried out by taking into account two conflicting needs:
the dynamics must be slow enough so that the known cases of drifts of one of the acquisition channels V10, V20 do not cause the model to drift by following the average of the channels V10, V20 (so that one can vote for one of the two channels when the deviation failure clears),
the dynamics must be fast enough so that the concerned speed ranges are nonetheless reset (in particular the speeds traveled up to the take-off speed, during take-off).

As there is one corrector 122 per 2D model segment or per 3D model plane, it is possible to adjust the correctors (mainly the integrating corrector) independently of each other:
rapid dynamics will then be applied to the speed ranges covered quickly during a classic mission. This allows to respond to the constraint of resetting these speed ranges in a very short time,
slow dynamics will be applied to the speed ranges over which the reset time is not a strong constraint (examples: ground idle, cruising, climb). In the case of pressure Ps3, this allows to best guard against the risks of resetting on the average of the channels Ps3 in the event of a drift of one of the two over these speed ranges.

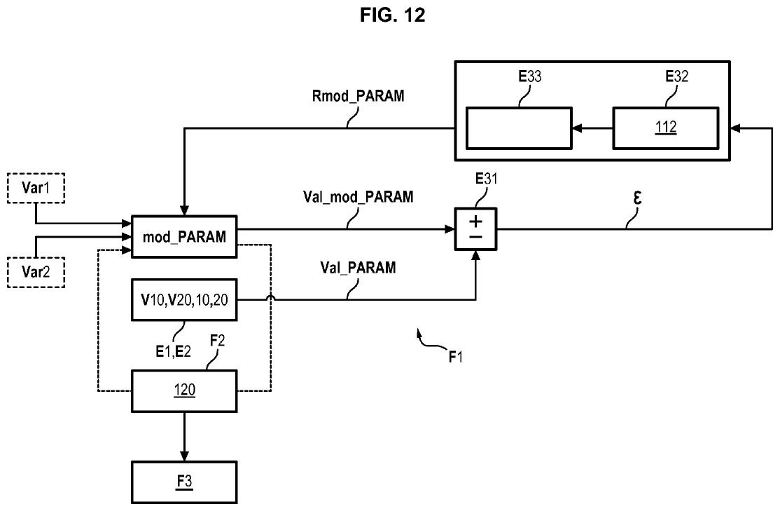

Thirdly, a method for analyzing the aging of a turbine engine will be described, as illustrated in FIG. 12. The example with the pressure Ps3 and the previous recalibration models will be taken, but the principle is applicable in the same way to any resetting method allowing to generate a reset model Rmod_PARAM.

At each resetting, step E3 is implemented and a “reset” model mod_PARAM (mod_Ps3, mod_Ps3/P25, etc.) is generated. When the purpose of this resetting is to allow a more efficient arbitration, the reset model mod_Ps3/P25 replaces the model mod_Ps3/P25 previously which becomes in fact obsolete. In this regard, an overwrite can be performed in the memory 120.

However, as each model mod_Ps3/P25 differs from the previous model (on a few segments or a few planes, at a minimum), it is possible to observe, step by step, the overall evolution of the model mod_Ps3/P25 by comparing all (or a certain number) of the reset models.

Thus, the various resetting methods described above are advantageously implemented in a method for measuring the aging of a turbine engine.

The turbine engine analysis method thus comprises a step F1 of implementing a resetting method comprising steps E1, E2, E3, E4 and a step F2 of storing the model mod_PARAM reset in a memory, which may be the memory 120. Unlike step E4, which may involve deleting the previous model, step F2 involves a definitive saving (that is to say a non-transitory saving) of the model mod_PARAM.

Steps F1 and F2 are repeated at least twice and preferably a large number of times.

It should be noted in particular that the behavior of a compressor can be degraded in different ways depending on its environment (cold, sand, etc) or unforeseen events (ingestion of a bird causing pumping or slight damage to the blades). The resetting allows the model to “age” with its engine. It must therefore be able to reset on one or two missions, but not be sensitive to variations in Ps3 over a few seconds.

As it is a matter of analyzing the turbine engine, that is to say of seeing its evolution over time, it is preferable that the memory 120 stores corrected models mod_PARAM generated at time intervals greater than the day, or even the last one month or trimester or semester.

Once all these data were acquired, a comparison step F3 is implemented by the processor 110 to compare the different reset models mod_PARAM. This comparison allows to deduce the state of the turbine engine.

In the case of pressure Ps3 for example, at the same PCN25R, a “young” compressor HP will have a higher Ps3 than an “old” compressor HP. The degradation of the compression ratio therefore results in the lowering of the Ps3 at a given PCN25R. The comparison of the models therefore allows to deduce a change in the condition of the engine.

Step F3 can be performed by the calculation unit 100 directly, so that the state of the turbine engine or of the aircraft is known as soon as an operator so requires. Alternatively, this step F3 is done in the design office, after data recovery. Likewise, step F2 can be carried out using the memory 120 of the calculation unit, but the reset models Rmod_PARAM can also be transmitted to a memory external to the aircraft or to the turbine engine, in particular in a design office, to then implement the state F3.

For example, an analysis of the aging of the high-pressure compressor can be established thanks to the evolution of the model mod_Ps3/P25(PCNR25R). As the compressor efficiency decreases over time, monitoring the models mod_Ps3/P25(PCNR25R) provides continuous information reflecting the current compressor.

1. A method for correcting a model of operating parameter of a turbine engine or of an aircraft, the model being used to arbitrate between two acquisition channels of the operating parameter, the two acquisition channels involving two sensors, the model being stored in a memory, the model expressing the operating parameter as a function at least of one parameter of the compressor and comprising the following steps:
E1: measuring an operating parameter value, by one of the two sensors, and
E2: correcting the model using the measurement of the operating parameter value.

2. The method according to claim 1, wherein the model is defined as a law by segment indicating the value of said operating parameter as a function of a variable, or being defined as a law by plane indicating the value of said operating parameter as a function of two variables, said law being affine on each segment or being affine on each plane, the model being stored in a memory,
the method comprising the following steps:
obtaining a value of the operating parameter (step E1),
calculating an error by comparing said value of the operating parameter with the corresponding value of the model, said value of the model belonging to one of the segments or planes of the model (step E31),
applying a corrector by minimizing said error to determine a correction (step E32),
correcting the segment of the model or the plane of the model using the correction, to reposition said segment or plane and thus obtain a corrected model of the operating parameter (step E33).

3. The method according to claim 1 wherein the model is a model of static pressure upstream of the combustion chamber in a turbine engine comprising a compressor and the operating parameter is a static pressure upstream of the combustion chamber.

4. The method according to claim 3, wherein the model is a model of the static pressure upstream of the combustion chamber on the compressor pressure.

5. The method according to claim 3, wherein the model is expressed as a function of the compressor speed reduced on the temperature of said compressor.

6. The method according to claim 5, wherein the step of correcting is performed on the model as a function of the compressor speed reduced on the temperature of said compressor.

7. The method according to claim 3, wherein the compressor is a high-pressure compressor, when the turbine engine further comprises a low-pressure compressor upstream of the high-pressure compressor.

8. The method according to claim 3, wherein the model is defined by segment according to and wherein the correcting step consists in correcting each segment.

9. The method according to claim 8, wherein on each segment the model is linear.

10. The method according to claim 8, wherein the step of correcting by segment is carried out using a corrector, for example an integral corrector.

11. The method according to claim 5, wherein the model is further expressed as a function of the low-pressure compressor speed reduced on the temperature of said compressor.

12. The method according to claim 3, wherein the model is further expressed as a function of the total external pressure.

13. The method according to claim 11, wherein the model is defined by plane and the correcting step consists in correcting each plane.

14. The method according to claim 3, wherein the model to be corrected is selected based on the level of aircraft air bleed in the compressors and the memory stores a plurality of models expressed as a function of the aircraft air bleed.

15. The method according to claim 2, wherein the step of obtaining the value of the operating parameter is performed by:
a direct measurement of said operating parameter using a sensor, or
a measurement of a third-party parameter on which said operating parameter depends, or
a simulation.

16. The method according to claim 2, wherein the corrector is a PID corrector or an integral corrector.

17. The method according to claims 2 wherein, when the model is a law by segment, the step of correcting is done by freezing a first point of the segment and by moving a second point of the segment using the correction, the first point and the second point preferably being the ends of the segment.

18. The method according to claim 2, wherein, when the model is a law by segment, the step of correcting is done by not keeping any point of the segment fixed, for example by moving the two ends of the segment using the correction.

19. The method according to claim 18, wherein the movement of the ends of the segment is done depending on their respective distance from said corresponding value of the Ps3 model.

20. The method according to claim 18, wherein the distribution of the correction to be applied to one end of the segment is equal to the ratio of the distance of the corresponding value of the model to the other end of the segment, over the length of the segment.

21. The method according to claim 17, wherein the step of correcting the segment of the model comprises a linear interpolation between two corrected points.

22. The method according to claim 2, wherein, when the model is a law by plane, the plane has the shape of a rectangle which is cut into triangles, and the step of correcting is done by freezing one or two vertices of the triangle and moving the last two vertices or the last vertex of the triangle using the correction.

23. The method according to claim 2, wherein, when the model is a law by plane, the plane is cut into triangles, and the step of correcting is done by moving the three vertices of the triangle.

24. The method according to claim 23, wherein the movement of each vertex of the triangle is done depending on the area of the sub-triangle defined by the other two vertices and said corresponding value of the model.

25. The method according to claim 24, wherein the distribution of the correction to be applied to a vertex of the triangle is equal to the ratio of the area of the sub-triangle defined by the other vertices and said corresponding value of the model, to the area of the triangle.

26. The method according to claim 22, wherein the step of correcting the triangle comprises a linear interpolation from the corrected points.

27. The method according to claim 2, wherein the operating parameter is the static pressure upstream of the combustion chamber or the operating parameter is the static pressure upstream of the combustion chamber divided by the compressor pressure and wherein
the variable is, when the model is a law by segment, the high-pressure compressor speed, reduced on the temperature of said compressor and
the variables are, when the model is a law by plane, the high-pressure compressor speed reduced on the temperature of said compressor and the low-pressure compressor speed reduced on the temperature of said compressor, or the high-pressure compressor speed reduced on the temperature of said compressor and the total external pressure.

28. The method according to claim 2, wherein the model to be corrected is selected according to a variable, the memory stores a plurality of models expressed as a function of the aircraft air bleed, the variable possibly being the level of aircraft air bleed in the compressors.

29. The method according to claim 2, wherein the corrector gains are different for different segments or planes of the model.

30. A method for arbitrating between two acquisition channels of an operating parameter of a turbine engine or of an aircraft, the two acquisition channels involving two sensors, said method comprising the following steps:
A1: implementing a method for correcting a model of operating parameter of a turbine engine or of an aircraft according to claim 1, the model being used to arbitrate between two acquisition channels of the operating parameter, the two acquisition channels involving two sensors, the model being stored in a memory, the model expressing the operating the following steps:
E1: measuring an operating parameter value, by one of the two sensors,
E2: correcting the model using the measurement of the operating parameter value.
A2: selecting the acquisition channel closest to the reset model.

31. A method for analyzing the aging of a turbine engine, the method consisting in implementing the following steps:
F1: Implementing a method for correcting a model of operating parameter of a turbine engine or of an aircraft according to claim 1, the model being used to arbitrate between two acquisition channels of the operating parameter, the two acquisition channels involving two sensors, the model being stored in a memory, the model expressing the operating parameter as a function at least of one parameter of the compressor and comprising the following steps:
E1: measuring an operating parameter value, by one of the two sensors
E2: correcting the model using the measurement of the operating parameter value.
F2: Saving the corrected model in a non-volatile memory,
steps F1 and F2 being repeated at least twice, and preferably more,
F3: Comparing the different corrected models to deduce an evolution of the state of the turbine engine therefrom.
